(19) United States
(12) Patent Application Publication
(10) Pub. No.: US 2026/0308967 A1
(43) Pub. Date: Oct. 8, 2026

(54) DRIVE ARRANGEMENT FOR THE MOTORIZED ADJUSTMENT OF A HATCH LEAF ARRANGEMENT OF A MOTOR VEHICLE

(71) Applicant: Brose Fahrzeugteile SE & Co. Kommanditgesellschaft, Bamberg, Bamberg (DE)

(72) Inventors: Shane Alexander, Ortonville, MI (US); Leo Kroener, Bischberg (DE); Daniel Schnapp, Ebensfeld (DE); Mark Farrugia, Clarkston, MI (US); Michael Kidd, Oxford, MI (US); Timothy Marion, Oxford, MI (US); Deon McGuire, Oxford, MI (US); David Rosales, Holly, MI (US); Derek Sikora, Lake Orion, MI (US); Kim Taylor, Farmington Hills, MI (US); Sascha Wagner, Lake Orion, MI (US)

(21) Appl. No.: 19/172,376

(22) Filed: Apr. 7, 2025

(51) Int. Cl. E05F 15/611

(52) U.S. Cl. CPC E05F 15/611; E05Y 2900/544

(57) ABSTRACT

A drive arrangement for motorized adjustment of a hatch leaf arrangement of a motor vehicle, wherein the hatch leaf arrangement has a hatch leaf that can be moved by the aid of hatch kinematics between an open position and a closed position about a geometric hatch axis, wherein the drive arrangement is equipped with an electric drive for providing a drive force, wherein the drive has an output element, wherein the drive arrangement has a drive coupling, wherein the drive coupling has an output element coupling piece, wherein, in an end-mounted state of the drive arrangement, the output element and the output element coupling piece overlap each other axially in an axial end position and are secured against rotation relative to each other, so that the output element transmits the drive force to the drive coupling for motorized adjustment of the hatch leaf.

### FIELD OF THE TECHNOLOGY

Various embodiments relate to a drive arrangement for motorized adjustment of a hatch leaf arrangement of a motor vehicle, as well as a hatch leaf arrangement of a motor vehicle.

### BACKGROUND

The known prior art (DE 20 2018 101 003 U1) relates to a drive arrangement for motorized adjustment of a hatch leaf arrangement of a motor vehicle, in particular a pickup truck, wherein the hatch leaf arrangement has a hatch leaf that can be moved by the aid of hatch kinematics between an open position and a closed position about a geometric hatch axis, wherein the drive arrangement is equipped with an electric drive for providing a drive force, wherein the drive has an output element, wherein the drive arrangement has a drive coupling, wherein the drive coupling has an output element coupling piece, wherein, in an end-mounted state of the drive arrangement, the output element and the output element coupling piece overlap each other axially in an axial end position and are secured against rotation relative to each other, so that the output element transmits the drive force to the drive coupling for motorized adjustment of the hatch leaf.

### SUMMARY

Nowadays, the hatch leafs of motor vehicles, especially pickup trucks, are increasingly equipped with a drive arrangement that has an electric drive. Since the motor vehicle is still without power during the assembly process on the production line, the hatch leaf has to be closed manually several times. At this point, the optional electric drive is already installed, and the drive's output element is positively engaged with the vehicle body, namely with a body-side output element coupling piece. Consequently, in addition to the flap's weight, the worker also has to overcome the return torque of the drive when manually closing. The force required because of the additional drive often exceeds the permissible load capacity of the worker to close the hatch leaf.

The challenge here is to improve upon the known prior art.

Some embodiments are based on the problem of designing and further developing the known drive arrangement such that a further optimization is achieved with respect to the aforementioned challenge.

The above problem is solved by various features described herein.

A “hatch leaf” of a hatch leaf arrangement of a motor vehicle is to be understood in a brought sense. This includes in particular any kind of doors of a motor vehicle such as side doors or back doors as well as tailgates, trunk lids or engine hoods. This also includes the rear hatch leaf of a pickup truck.

Essential to some embodiments is the basic idea of, during the assembly process on the production line, indeed already mounting the hatch leaf so that it can pivot on the body of the motor vehicle, but still not yet providing any positive coupling between the drive's output element and the body or the output element coupling piece. Only in a fully assembled state (“end-mounted” state) of the drive arrangement are the output element and the body or the output element coupling piece secured against rotation relative to each other. Until this has taken place, the worker can move the hatch leaf relatively easily, since the return torque of the drive does not yet apply.

Specifically, it is proposed that the output element and the output element coupling piece, in a preassembled state of the drive arrangement, overlap each other axially in the axial end position and can be rotated relative to each other about the geometric hatch axis.

Various embodiments specify a structural solution by means of which the output element can be held in a non-rotatable manner on the output element coupling piece and thus relative to the body. For this purpose, the drive arrangement is equipped with a securing element that can secure the output element and the output element coupling piece against rotation relative to each other in an especially simple way, thereby ensuring safe and reliable functioning of the drive arrangement. By allowing relative rotation, after all assembly steps that require a pivoting of the hatch leaf, the output element and the output element coupling piece can be brought into a securing position in which two securing element receiving structures are defined relative to each other, so that the securing element can engage in these in a form-fit manner in the circumferential direction.

According to various embodiments, provision is made that, in the defined relative orientation of the drive-side securing element receiving structure and the body-side securing element receiving structure, the securing element can be brought into its end position producing the anti-rotation lock by a lead-forward arrangement of the drive arrangement or manually. This has the advantage of simplified assembly and allows the assembly process to be streamlined and accelerated.

According to various embodiments, the output element coupling piece is of two-part design and has a first coupling piece part and a second coupling piece part, which facilitates attachment of the hatch leaf to the body. Through this division, the output element can be positioned especially easily on or in a radially, in particular vertically upwardly, open part of the output element coupling piece, and the output element coupling piece can then be completed, whereby the radial opening is closed. As a result, the output element is already located in its intended axial end position, which it will also occupy later during regular operation of the drive arrangement.

According to various embodiments, a hatch leaf arrangement of a motor vehicle, in particular a pickup truck, is provided, wherein the hatch leaf arrangement has a hatch leaf that can be moved by the aid of hatch kinematics between an open position and a closed position about a geometric hatch axis, wherein the drive arrangement is equipped with an electric drive for providing a drive force, wherein the drive has an output element, wherein the drive arrangement has a drive coupling, wherein the drive coupling has an output element coupling piece, wherein, in an end-mounted state of the drive arrangement, the output element and the output element coupling piece overlap each other axially in an axial end position and are secured against rotation relative to each other, so that the output element transmits the drive force to the drive coupling for motorized adjustment of the hatch leaf.

In some embodiments, it can be essential in this regard that the output element and the output element coupling piece, in a preassembled state of the drive arrangement, overlap each other axially in the axial end position and can be rotated relative to each other about the geometric hatch axis.

All previously outlined details pertaining to the proposed drive arrangement are incorporated by reference.

Various embodiments provide a drive arrangement for motorized adjustment of a hatch leaf arrangement of a motor vehicle, in particular a pickup truck, wherein the hatch leaf arrangement has a hatch leaf that can be moved by the aid of hatch kinematics between an open position and a closed position about a geometric hatch axis, wherein the drive arrangement is equipped with an electric drive for providing a drive force, wherein the drive has an output element, wherein the drive arrangement has a drive coupling, wherein the drive coupling has an output element coupling piece, wherein, in an end-mounted state of the drive arrangement, the output element and the output element coupling piece overlap each other axially in an axial end position and are secured against rotation relative to each other, so that the output element transmits the drive force to the drive coupling for motorized adjustment of the hatch leaf, wherein the output element and the output element coupling piece, in a preassembled state of the drive arrangement, overlap each other axially in the axial end position and can be rotated relative to each other about the geometric hatch axis.

In various embodiments, the output element has a drive-side securing element receiving structure and the output element coupling piece has a body-side securing element receiving structure, wherein the drive arrangement has a securing element, wherein, in the preassembled state of the drive arrangement, the output element and the output element coupling piece can be rotated relative to each other about the geometric hatch axis to a securing position in which the drive-side securing element receiving structure and the body-side securing element receiving structure are definedly oriented relative to each other, and wherein, in the defined relative orientation of the drive-side securing element receiving structure and the body-side securing element receiving structure, the securing element is moved through the body-side securing element receiving structure or a portion of the body-side securing element receiving structure into the drive-side securing element receiving structure, so that the securing element penetrates both the body-side securing element receiving structure or a portion of the body-side securing element receiving structure and the drive-side securing element receiving structure, thereby securing the output element and the output element coupling piece against rotation relative to each other.

In various embodiments, in the defined relative orientation of the drive-side securing element receiving structure and the body-side securing element receiving structure, the securing element is moved crosswise or parallel to the geometric hatch axis, by a lead-forward arrangement of the drive arrangement or manually, through the body-side securing element receiving structure or the portion of the body-side securing element receiving structure into the drive-side securing element receiving structure.

In various embodiments, the output element coupling piece is configured in two parts and has a first coupling piece part and a second coupling piece part, and wherein the first coupling piece part and the second coupling piece part can be brought together crosswise to the geometric hatch axis in the course of preassembly and, in the preassembled and end-mounted state of the drive arrangement, accommodate the output element between them.

Various embodiments provide a hatch leaf arrangement of a motor vehicle, in particular a pickup truck, wherein the hatch leaf arrangement has a hatch leaf that can be moved by the aid of hatch kinematics between an open position and a closed position about a geometric hatch axis, wherein the drive arrangement is equipped with an electric drive for providing a drive force, wherein the drive has an output element, wherein the drive arrangement has a drive coupling, wherein the drive coupling has an output element coupling piece, wherein, in an end-mounted state of the drive arrangement, the output element and the output element coupling piece overlap each other axially in an axial end position and are secured against rotation relative to each other, so that the output element transmits the drive force to the drive coupling for motorized adjustment of the hatch leaf, wherein the output element and the output element coupling piece, in a preassembled state of the drive arrangement, overlap each other axially in the axial end position and can be rotated relative to each other about the geometric hatch axis.

### BRIEF DESCRIPTION OF THE DRAWINGS

Below, various aspects will be explained in more detail with reference to the drawing, which merely depicts exemplary embodiments. In the drawing

FIG. 1a shows the rear area of a motor vehicle with a proposed hatch leaf arrangement, which is equipped with a proposed drive arrangement,

FIG. 1b shows a detailed view of the proposed drive arrangement,

FIG. 2a shows the proposed drive arrangement in an exploded view,

FIG. 2b shows the preassembled state of the drive arrangement, and

FIG. 2c shows the drive arrangement in the end-mounted state of the drive arrangement.

### DETAILED DESCRIPTION

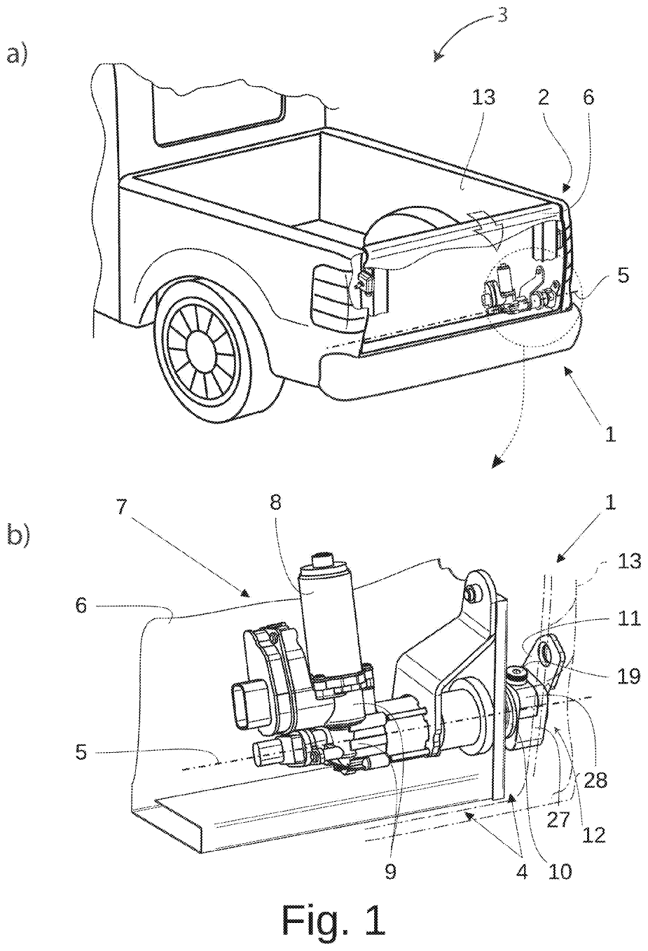

The drive arrangement 1 shown in the drawing is designed for the motorized adjustment of a hatch leaf arrangement 2 of a motor vehicle 3. The hatch leaf arrangement 2 has a hatch leaf 6 which can be moved by the aid of hatch kinematics 4 between an open position (not shown) and the closed position shown in FIG. 1 about a geometric hatch axis 5.

The term “hatch kinematics” 4 encompasses all components that permit movement of the hatch leaf 6. In various embodiments, the hatch kinematics 4 are configured in such a way that the hatch leaf 6 can pivot about a geometric hatch axis 5, although other configurations of the hatch kinematics 4 are conceivable.

In the present case, the motor vehicle 3 can be a pickup truck, whereby the hatch leaf 6 is arranged such that an opening movement indicated by the arrow in Fig. la is supported by the weight force of the hatch leaf 6. A closing movement requires a flap movement at least partially against the weight force, for which the drive arrangement 1 is provided to support the operator when moving the hatch leaf 6.

As shown in FIG. 1b, the drive arrangement 1 is equipped with an electric drive 7 for providing a drive force. The drive 7 in particular comprises an electric drive motor 8, in various embodiments a rotary drive motor 8, as well as a transmission 9. The transmission 9 converts the rotary drive motion generated by the drive motor 8 into a rotary motion of an output element 10 about the geometric hatch axis 5.

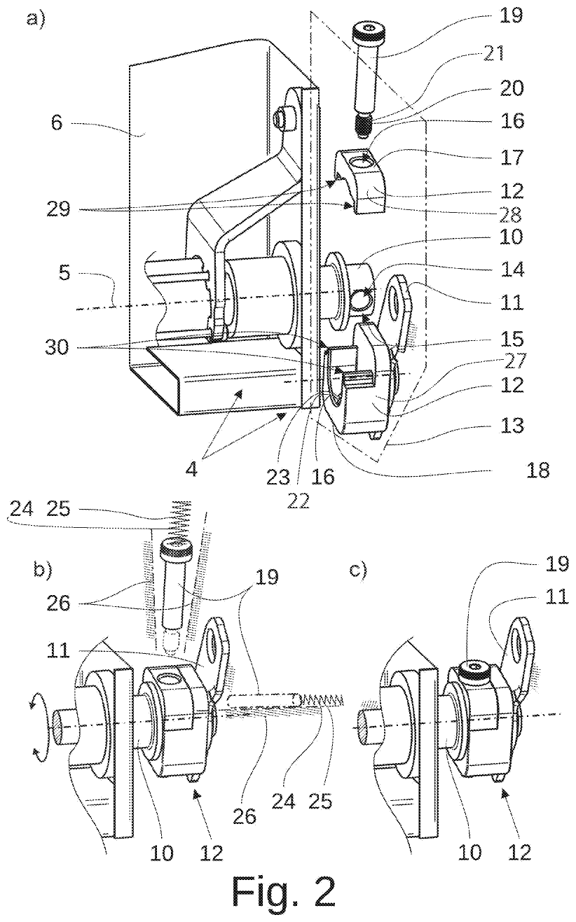

The drive arrangement 1 has the output element 10 and a drive coupling 11, which can be seen more clearly in FIG. 2. In the end-mounted state of the drive arrangement 1, the output element 10 transmits the drive force generated by the drive 7 to the drive coupling 11 for the motorized adjustment of the hatch leaf 6. In various embodiments, the output element 10 is configured as a drive pin that engages in an output element coupling piece 12, in particular a receptacle, of the drive coupling 11 in order to transmit a drive torque produced by the drive force.

The “end-mounted” state of the drive arrangement is that state in which the drive arrangement ensures its intended operation. A “preassembled” state of the drive arrangement mentioned below precedes the end-mounted state. Not all assembly steps required to achieve the end-mounted state, in which the drive arrangement ensures its intended operation, have yet been carried out in the preassembled state.

Furthermore, the drive coupling 11 is formed as a body attachment 13, which in the end-mounted state of the drive arrangement 1 is attached in a non-rotatable manner to the body 13 of the motor vehicle 3, whereas the drive 7 is assigned to the hatch leaf 6. A reversed arrangement is conceivable, in which the drive 7 is assigned to the body 13.

The drive force can be the force exerted by the drive 7 on the output element 10 via the drive motor 8 and transmission 9, which here acts as a drive torque about the axis of rotation.

To sum up, the embodiments shown in the figures concern a drive arrangement 1 for the motorized adjustment of a hatch leaf arrangement 2 of a motor vehicle 3, here a pickup truck, wherein the hatch leaf arrangement 2 has a hatch leaf 6 that can be moved by the aid of hatch kinematics 4 between an open position and a closed position about a geometric hatch axis 5, for pivotable attachment to a body 13 of the motor vehicle 3 about the geometric hatch axis 5.

The drive arrangement 1 is equipped with an electric drive 7 for providing a drive force, the drive 7 having an output element 10 for transferring the drive force to the body 13 of the motor vehicle 3.

Moreover, as shown in the figures, the drive arrangement 1 includes a drive coupling 11 for non-rotatable attachment to the body 13 of the motor vehicle 3, wherein the drive coupling 11 has an output element coupling piece 12 for coupling with the output element 10, and wherein the output element coupling piece 12 is non-rotatable relative to the rest of the drive coupling 11 and thus, when the drive coupling 11 is non-rotatably attached to the body 13 of the motor vehicle 3, it is also non-rotatable relative to the body 13.

In an end-mounted state of the drive arrangement 1, the output element 10 and the output element coupling piece 12 overlap each other axially in an axial end position and are secured against rotation relative to each other (FIG. 2c), so that the output element 10 transfers the drive force to the drive coupling 11 for motorized adjustment of the hatch leaf 6.

The term “axial” refers to the course of the geometric hatch axis 5. “Axially overlapping each other” accordingly means that the aforementioned components overlap one another in the direction of the geometric hatch axis 5, in particular interlock or are plugged into each other in the direction of the geometric hatch axis 5.

“In an axial end position” means that the output element 10 and the output element coupling piece 12 are in the intended axial end position for the intended operation of the drive arrangement 1.

It is now essential that the output element 10 and the output element coupling piece 12, in a preassembled state of the drive arrangement 1, overlap each other axially in the axial end position and can be rotated relative to each other about the geometric hatch axis 5.

During assembly, therefore, a state is reached in which the output element 10 and the output element coupling piece 12 are already in the intended axial end position for the intended operation of the drive arrangement 1, but they are not yet secured against rotation relative to each other, i.e., they are not yet locked rotationally relative to each other (FIG. 2b). In this way, before the drive arrangement 1 reaches the end-mounted state, at least one more assembly step requiring that the output element 10 be able to rotate relative to the output element coupling piece 12 about the geometric hatch axis 5, can be carried out, here the creation of a rotational lock between the output element 10 and the output element coupling piece 12.

Furthermore, it is provided in some embodiments that the output element 10 has a drive-side securing element receiving structure 14.

For example, a drive-side securing element receiving structure 14 is formed by a hole running parallel or transverse to the geometric hatch axis 5, or as shown in FIG. 2, radially into the output element 10, in particular a blind hole or through-hole, or it is formed by a groove running parallel or transverse to the geometric hatch axis 5, or it is formed by an uneven outer contour running in the circumferential direction around the geometric hatch axis 5, in particular an external toothing. In the present exemplary embodiment shown here, as FIG. 1 and FIG. 2 illustrate, as the drive-side securing element receiving structure 14 a round through-hole running radially into the output element 10 is provided, particularly in an axial end section 15 of the output element 10 projecting laterally from the hatch leaf 6.

The term “radial” means orthogonal to the course of the geometric hatch axis 5.

In addition, it is provided that the output element coupling piece 12 has a body-side securing element receiving structure 16.

For example, a body-side securing element receiving structure 16 is formed by at least one hole running parallel or transverse to the geometric hatch axis 5 or, as shown in FIG. 2, radially into the output element coupling piece 12, in particular a blind hole or through-hole, or it is formed by a groove running parallel or transverse to the geometric hatch axis 5 in the preassembled and/or end-mounted state of the drive arrangement 1, or it is formed by an uneven inner contour running in the circumferential direction around the geometric hatch axis 5 in the preassembled and/or end-mounted state of the drive arrangement 1, in particular with a radially outward-oriented recess or a radially inward-oriented projection. In the present exemplary embodiment, as shown in FIG. 1 and FIG. 2, two round holes running radially into the output element coupling piece 12 in the preassembled and/or end-mounted state of the drive arrangement 1 serve as the body-side securing element receiving structure 16. One hole here extends radially as a through-hole through a first, in FIG. 1 and FIG. 2 upper, circumferential section 17 of the output element coupling piece 12, and the other hole extends inward radially as a blind hole into a second, in FIG. 1 and FIG. 2 lower, circumferential section 18 of the output element coupling piece 12. Alternatively, it is also conceivable that a hole serving as the body-side securing element receiving structure 16 extends axially through an axial portion of the output element coupling piece 12.

The drive arrangement 1 also has a securing element 19. As explained below, in the preassembled state of the drive arrangement 1 (FIG. 2b), this element 19 is not yet in engagement with both the drive-side securing element receiving structure 14 and the body-side securing element receiving structure 16, but in the further course of assembly, as soon as the output element 10 is oriented in a defined manner relative to the output element coupling piece 12 in the circumferential direction about the geometric hatch axis 5, it engages with both the drive-side securing element receiving structure 14 and the body-side securing element receiving structure 16 (FIG. 2c).

Accordingly, it is further provided that, in the preassembled state of the drive arrangement 1, the output element 10 and the output element coupling piece 12 can be rotated relative to each other about the geometric hatch axis 5 to a securing position in which the drive-side securing element receiving structure 14 and the body-side securing element receiving structure 16 are oriented in a defined manner relative to each other, in particular oriented so they align with each other. Furthermore, in this defined, in particular aligned, orientation of the drive-side securing element receiving structure 14 and the body-side securing element receiving structure 16, the securing element 19 is moved through the body-side securing element receiving structure 16 or a portion of the body-side securing element receiving structure 16 into the drive-side securing element receiving structure 14, so that the securing element 19, as shown in FIG. 2c), penetrates both the body-side securing element receiving structure 16 or a portion of the body-side securing element receiving structure 16 and the drive-side securing element receiving structure 14, thereby securing the output element 10 and the output element coupling piece 12 against rotation relative to each other, and thus the end-mounted state of the drive arrangement 1 is achieved.

“Definedly oriented relative to each other” means that the drive-side securing element receiving structure 14 and the body-side securing element receiving structure 16 are oriented in such a way as to together form a receiving space for the securing element 19. Only in this defined relative placement the securing element 19 is fully and suitably received in the receiving space to fulfill its intended purpose (FIG. 2c). “Aligned with each other” means that the drive-side securing element receiving structure 14 and the body-side securing element receiving structure 16 together form a channel with a common geometric longitudinal center axis. If, for example, both the drive-side securing element receiving structure 14 and the body-side securing element receiving structure 16 are holes, as in the figures, “aligned with each other” means that the two holes run coaxially. If, for instance, both the drive-side securing element receiving structure 14 and the body-side securing element receiving structure 16 are grooves, “aligned with each other” means that the two grooves run next to each other and together form a hole in which each groove forms a portion of the hole's circumference.

For this purpose, the securing element 19 in particular has a shape that corresponds to the drive-side securing element receiving structure 14 and the body-side securing element receiving structure 16; that is, it fits, in particular without play, into the drive-side securing element receiving structure 14 and the body-side securing element receiving structure 16.

For example, the securing element 19 may be formed as a bolt-shaped component, as shown in FIG. 2a), in particular having a threaded profile 20 at least on one end of the bolt-shaped component, or may be formed (not shown here) as a sleeve-or ring-shaped component, especially with a conical shape for producing a play-free seat in the end-mounted state of the drive arrangement 1.

In the end-mounted state of the drive arrangement 1, the bolt-shaped component serving as securing element 19 extends, in particular, as shown in FIGS. 1 and 2, through the through-hole that runs radially through the first, upper circumferential section 17 of the output element coupling piece 12 in FIGS. 1 and 2, then further through the through-hole that runs radially through the output element 10, and finally into the blind hole that runs inward radially into the second, lower circumferential section 18 of the output element coupling piece 12 in FIGS. 1 and 2. In various embodiments, at one end of the bolt-shaped component there is a fixing section 21, in particular having a threaded profile 20, and in the blind hole that runs inward radially into the second circumferential section 18 of the output element coupling piece 12 there is a corresponding fixing receptacle 22, in particular with a mating thread profile 23. Here, the threaded profile 20 is an external thread, and the mating thread profile 23 is an internal thread. In this way, in the end-mounted state of the drive arrangement 1, the securing element 19—i.e. the bolt-shaped component—is secured against being pushed out, so that the now created rotational lock between the output element 10 and the output element coupling piece 12 cannot accidentally come loose.

If the securing element 19 is a sleeve-or ring-shaped component as described above, then in the end-mounted state of the drive arrangement 1 it extends, for example, radially between the output element 10 and the output element coupling piece 12, wherein in particular, on the one hand, an uneven outer contour running in the circumferential direction around the geometric hatch axis 5, especially an external toothing, serves as the drive-side securing element receiving structure 14 of the output element 10 and is in form-fit engagement in the circumferential direction with a corresponding uneven inner contour running in the circumferential direction around the geometric hatch axis 5, especially an internal toothing, on the sleeve- or ring-shaped component; and in particular, on the other hand, an uneven inner contour running in the circumferential direction around the geometric hatch axis 5, especially with a radially outwardly oriented recess or a radially inwardly oriented projection, serves as the body-side securing element receiving structure 16 of the output element coupling piece 12 and is in form-fit engagement in the circumferential direction with a corresponding uneven outer contour running in the circumferential direction around the geometric hatch axis 5, especially with a radially inwardly oriented projection or a radially outwardly oriented recess, on the sleeve-or ring-shaped component.

In the preassembled state of the drive arrangement 1, in particular, the body-side securing element receiving structure 16 and the drive-side securing element receiving structure 14, as shown in FIG. 2b), are initially not definedly oriented relative to each other, in particular not aligned, but only become definedly oriented relative to each other, especially aligned, when the output element 10 is twisted about the geometric hatch axis 5 relative to the output element coupling piece 12 to the point that the securing element 19, as shown in FIG. 2c), fits both into the body-side securing element receiving structure 16 and into the drive-side securing element receiving structure 14.

Therefore, in the preassembled state of the drive arrangement 1, when the body-side securing element receiving structure 16 and the drive-side securing element receiving structure 14 are not yet definedly oriented relative to each other, particularly not aligned, the bolt-shaped component acting as securing element 19 is not yet passing through the through-hole that extends radially through the output element 10, nor is it entering the blind hole that extends inward radially into the second, lower circumferential section 18 in FIGS. 1 and 2 of the output element coupling piece 12. However, it is conceivable that at this time the bolt-shaped component already passes through the through-hole that extends radially through the first, upper circumferential section 17 of the output element coupling piece 12 in FIGS. 1 and 2, and in particular rests against the radial outer side of the output element 10 until the body-side securing element receiving structure 16 is properly oriented relative to the drive-side securing element receiving structure 14.

In the case of a sleeve-or ring-shaped component as described above serving as securing element 19, it is correspondingly the case that, in the preassembled state of the drive arrangement 1, if the body-side securing element receiving structure 16 and the drive-side securing element receiving structure 14 are not yet definedly oriented relative to each other, particularly not aligned, the sleeve-or ring-shaped component is not yet engaging axially in the uneven inner contour running in the circumferential direction around the geometric hatch axis 5 of the output element coupling piece 12. It is conceivable that the sleeve-or ring-shaped component then rests on the output element 10 and, in particular via its uneven inner contour running in the circumferential direction around the geometric hatch axis 5, especially via an internal toothing, is in form-fit engagement in the circumferential direction with the uneven outer contour running in the circumferential direction around the geometric hatch axis 5, especially with an external toothing, on the output element 10, and in particular remains against an axial side of the output element coupling piece 12 until the body-side securing element receiving structure 16 is properly oriented relative to the drive-side securing element receiving structure 14.

In the preassembled state of the drive arrangement 1, the defined, especially aligned, orientation of the drive-side securing element receiving structure 14 and the body-side securing element receiving structure 16 can be achieved, in some embodiments, by operating the electric drive 7 and thus motor-rotating the output element 10 relative to the output element coupling piece 12 about the geometric hatch axis 5, as schematically indicated in FIG. 2b) by an arrow representing a rotational movement of the output element 10. Basically, according to another embodiment, it is also conceivable that for this purpose, in the preassembled state of the drive arrangement 1, one manually pivots the hatch leaf 6 relative to the output element coupling piece 12 about the geometric hatch axis 5, with the output element 10 following the movement of the hatch leaf 6.

Furthermore, as shown purely schematically in FIG. 2b), in some embodiments it can be provided that, in the defined, especially aligned, orientation of the drive-side securing element receiving structure 14 and the body-side securing element receiving structure 16, the securing element 19 is moved crosswise or parallel to the geometric hatch axis 5, either by a lead-forward arrangement 24 of the drive arrangement 1 or manually, through the body-side securing element receiving structure 16 or that portion of the body-side securing element receiving structure 16 into the drive-side securing element receiving structure 14.

In FIG. 2b), a compression spring 25 is schematically depicted in an associated guide 26 as the lead-forward arrangement 24. Two alternative variants are shown here, according to one of which the compression spring 25 acts crosswise or radially to the geometric hatch axis 5, and according to the other variant the compression spring 25 acts parallel to the geometric hatch axis 5. In some embodiments, the compression spring 25 generates a constant biasing of the securing element 19 toward its end position, which it occupies in the end-mounted state of the drive arrangement 1. This means that as soon as the drive-side securing element receiving structure 14 is aligned with the body-side securing element receiving structure 16, the securing element 19 is moved into its end position by the compression spring 25 and in particular held in this end position, so that, in the end-mounted state of the drive arrangement 1, the securing element 19 is secured against being pushed out. In a corresponding manner, the sleeve-or ring-shaped component mentioned above can also be moved into its end position as soon as the drive-side securing element receiving structure 14 is definedly oriented relative to the body-side securing element receiving structure 16.

Moreover, in some embodiments, the output element coupling piece 12 is of two-part configuration and, as especially FIG. 2a) illustrates, comprises a first coupling piece part 27 and a second coupling piece part 28. It is provided that, in the course of the preassembly, the first coupling piece part 27 and the second coupling piece part 28 can be brought together crosswise to the geometric hatch axis 5 and in the preassembled and end-mounted state of the drive arrangement 1 accommodate the output element 10 between them (FIG. 2b, FIG. 2c).

As a result, during preassembly, the output element 10 can be brought together with the output element coupling piece 12 crosswise to the geometric hatch axis 5.

After bringing together the first coupling piece part 27 and the second coupling piece part 28, they are not yet fixed relative to each other crosswise to the geometric hatch axis 5—although, in principle, this would also be conceivable, for example by means of a positive and/or frictional connection, in particular a snap connection, created when bringing the first coupling piece part 27 and the second coupling piece part 28 together. In the present case, as shown in FIG. 2b), the first coupling piece part 27 and the second coupling piece part 28 do indeed already touch in the preassembled state of the drive arrangement 1, namely because a securing contour 29 on the second coupling piece part 28 is in engagement with a corresponding securing counter-contour 30 on the first coupling piece part, so that here a form-fit is especially achieved crosswise to the geometric hatch axis 5. However, the first coupling piece part 27 and the second coupling piece part 28 are still loosely arranged relative to each other at this point, and are only fixed to each other by the securing element 19. For this purpose, in particular a thread engagement between the securing element 19 and the first coupling piece part 27 on one side—i.e. in the second circumferential section 18 of the output element coupling piece 12—and a bolt head that is larger than the hole cross section of the hole in the second coupling piece part 28 on the other side—i.e. in the first circumferential section 17 of the output element coupling piece 12—are provided, so that the securing element 19 fixes and in particular also secures the first coupling piece part 27 and the second coupling piece part 28 relative to each other, here together with the output element 10, and prevents them from rotating. In this context, the second circumferential section 18, in some embodiments, forms part of the first coupling piece part 27 of the output element coupling piece 12. The first, upper circumferential section 17 of the output element coupling piece 12 in FIGS. 1 and 2, in various embodiments, forms part of the second coupling piece part 28 of the output element coupling piece 12.

According to a further teaching, which has independent significance, it is proposed a hatch leaf arrangement 2 of a motor vehicle 3, in particular a pickup truck, wherein the hatch leaf arrangement 2 has a hatch leaf 6 that can be moved by the aid of hatch kinematics 4 between an open position and a closed position about a geometric hatch axis 5, wherein the drive arrangement 1 is equipped with an electric drive 7 for providing a drive force, wherein the drive 7 has an output element 10, wherein the drive arrangement 1 has a drive coupling 11, wherein the drive coupling 11 has an output element coupling piece 12, wherein, in an end-mounted state of the drive arrangement 1, the output element 10 and the output element coupling piece 12 overlap each other axially in an axial end position and are secured against rotation relative to each other, so that the output element 10 transmits the drive force to the drive coupling 11 for motorized adjustment of the hatch leaf 6.

According to this further teaching, it is essential that, in a preassembled state of the drive arrangement 1, the output element 10 and the output element coupling piece 12 overlap each other axially in the axial end position and can be rotated relative to each other about the geometric hatch axis 5.

All previously outlined details pertaining to the proposed drive arrangement 1 are incorporated by reference.

1. A drive arrangement for motorized adjustment of a hatch leaf arrangement of a motor vehicle, wherein the hatch leaf arrangement has a hatch leaf that can be moved by the aid of hatch kinematics between an open position and a closed position about a geometric hatch axis, wherein the drive arrangement is equipped with an electric drive for providing a drive force, wherein the drive has an output element, wherein the drive arrangement has a drive coupling, wherein the drive coupling has an output element coupling piece, wherein, in an end-mounted state of the drive arrangement, the output element and the output element coupling piece overlap each other axially in an axial end position and are secured against rotation relative to each other, so that the output element transmits the drive force to the drive coupling for motorized adjustment of the hatch leaf,
wherein the output element and the output element coupling piece, in a preassembled state of the drive arrangement, overlap each other axially in the axial end position and can be rotated relative to each other about the geometric hatch axis.

2. The drive arrangement according to claim 1, wherein the output element has a drive-side securing element receiving structure and the output element coupling piece has a body-side securing element receiving structure, wherein the drive arrangement has a securing element, wherein, in the preassembled state of the drive arrangement, the output element and the output element coupling piece can be rotated relative to each other about the geometric hatch axis to a securing position in which the drive-side securing element receiving structure and the body-side securing element receiving structure are definedly oriented relative to each other, and wherein, in the defined relative orientation of the drive-side securing element receiving structure and the body-side securing element receiving structure, the securing element is moved through the body-side securing element receiving structure or a portion of the body-side securing element receiving structure into the drive-side securing element receiving structure, so that the securing element penetrates both the body-side securing element receiving structure or a portion of the body-side securing element receiving structure and the drive-side securing element receiving structure, thereby securing the output element and the output element coupling piece against rotation relative to each other.

3. The drive arrangement according to claim 1, wherein, in a defined relative orientation of a drive-side securing element receiving structure and a body-side securing element receiving structure, the securing element is moved crosswise or parallel to the geometric hatch axis, by a lead-forward arrangement of the drive arrangement or manually, through the body-side securing element receiving structure or the portion of the body-side securing element receiving structure into the drive-side securing element receiving structure.

4. The drive arrangement according to claim 1, wherein the output element coupling piece is configured in two parts and has a first coupling piece part and a second coupling piece part, and wherein the first coupling piece part and the second coupling piece part can be brought together crosswise to the geometric hatch axis in the course of preassembly and, in the preassembled and end-mounted state of the drive arrangement, accommodate the output element between them.

5. A hatch leaf arrangement of a motor vehicle, wherein the hatch leaf arrangement has a hatch leaf that can be moved by the aid of hatch kinematics between an open position and a closed position about a geometric hatch axis, wherein a drive arrangement is equipped with an electric drive for providing a drive force, wherein the drive has an output element, wherein the drive arrangement has a drive coupling, wherein the drive coupling has an output element coupling piece, wherein, in an end-mounted state of the drive arrangement, the output element and the output element coupling piece overlap each other axially in an axial end position and are secured against rotation relative to each other, so that the output element transmits the drive force to the drive coupling for motorized adjustment of the hatch leaf,
wherein the output element and the output element coupling piece, in a preassembled state of the drive arrangement, overlap each other axially in the axial end position and can be rotated relative to each other about the geometric hatch axis.

6. The drive arrangement according to claim 1, wherein the motor vehicle is a pickup truck.

7. The hatch leaf arrangement according to claim 5, wherein the motor vehicle is a pickup truck.
